(19) United States
(12) Patent Application Publication
(10) Pub. No.: US 2007/0224952 A1
(43) Pub. Date: Sep. 27, 2007

(54) APPARATUS AND METHOD FOR SIGNAL SEPARATION VIA SPREADING CODES

(75) Inventors: Steven Jeffrey Goldberg, Downingtown, PA (US); Henry Leung, Calgary (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/683,225

(22) Filed: Mar. 7, 2007

Related U.S. Application Data
(60) Provisional application No. 60/780,234, filed on Mar. 8, 2006.

(51) Int. Cl. H04B 7/08

(52) U.S. Cl. 455/132

(57) ABSTRACT

A method and apparatus are provided for separating signals from a received combined signal in a wireless communication system. Combined signals are received by one or more antennas, demodulated and filtered. The combined signals are mixed with known scrambling codes of a target sector and possibly interfering sectors prior to signal separation, by which a separation matrix is created. The separation matrix is used to provide separate desired and interferer signals, such that the desired signals may be despread with known spreading codes for further decoder processing. In an alternate embodiment, the separation matrix is split according to scrambling and spreading code processing to decrease processing complexity. Feedback adjustment control may be used to adjust separation parameters based on generated separation matrices and separated signals.

### CROSS REFERENCE TO RELATED APPLICATION

This application claims priority U.S. Provisional Patent Application No. 60/780,234 filed on Mar. 8, 2006, the benefit of which is incorporated by reference as if fully set forth.

### FIELD OF INVENTION

The present invention relates to wireless communication systems. More particularly, the present invention relates to blind signal separation at a spread spectrum receiver based on scrambling codes and/or spreading codes.

### BACKGROUND

Wireless communication systems are well known in the art. Generally, such systems include a transmitter and a receiver that exchange communication signals with each other. Signals transmitted by the transmitter over a wireless medium and received by an intended receiver experience interference from other signals transmitted within the same or nearby frequency bands, and noise caused by various factors including defects in the receiver.

In a code division multiple access (CDMA) system employing direct sequence spread spectrum modulation, multiple signals are transmitted by one or more transmitters over a common frequency band using mutually orthogonal spreading codes so that they can be successfully decoded at a receiver. Coded information is multiplied by a high-rate spreading sequence prior to transmission at the transmitter. The receiver decodes the received spread spectrum signal by correlating it with the same spreading sequence to recover the original information. Mixing a signal with a high-rate spreading code spreads its spectral density over a wide band channel so that the interfering signals may be treated as additive white Gaussian noise (AWGN) for decoding at a receiver. Walsh codes are an example of commonly used spreading codes which are mutually orthogonal codes. Many systems, including second generation (2G) and third generation (3G) CDMA systems and CDMA2000 systems employ direct sequence spread spectrum.

To facilitate decoding wireless signals of interest at a particular receiver, signal separation techniques may be used. Blind signal separation may be used by a receiver that assumes little or no knowledge of the nature of the signals to be separated, or the transformations applied to the signals in the communication channel. In practical implementations of blind signal separation, statistical knowledge of signals is exploited. For example, it may be known at the receiver that the original signals, prior to transmission, contain mutually statistically independent or decorrelated information.

Three commonly used blind signal separation techniques are Principal Component Analysis (PCA), Independent Component Analysis (ICA), and Single Value Decomposition (SVD). FIG. 1 shows a conventional wireless receiver 100 employing ICA. Signals are received by one or more antennas 102, amplified by amplifier 104, demodulated by a modulating signal U, and converted to digital signals 109 using an analog-to-digital converter (ADC) 108. The digital signals 109 are processed by a PCA module 110, such that PCA processing reduces multidimensional data sets to lower dimensions to simplify further analysis (also known as the discrete Karhunen-Loève transform). Output signals 111 are used by an ICA signal separation processing module 112 to determine a separation matrix W. The signal separation processing module 112 uses the separation matrix W to produce separated signals 113 derived from the received signal. The separated signals 113 then undergo signal analysis in a decoder 114 that determines which of the separated signals 113 are of interest, such that the undesired signals may be discarded. The decision as to which signals are of interest may be a function of the application dependant processing module 116 and may not always involve the final signals to be decoded. For example, the application may call for identifying interferers and subtracting them from the total received signal, and then feeding the reduced signal to a waveform decoder (not shown). In this case, the signals of interest are the ones that ultimately end up being rejected.

The information 111 fed to the signal separation processing module 112 may be represented by M demodulated received signals xⱼ(t), j=1, . . . , M equal to unique sums of scaled of versions of N transmitted signals sₖ(t):

$$\begin{matrix}{x}_{1} ( t ) = {a}_{11} {s}_{1} ( t ) + … {a}_{1 k} {s}_{k} ( t ) + … {a}_{1 N} {s}_{N} ( t ) \\ ⋮ \\ {x}_{j} ( t ) = {a}_{j 1} {s}_{1} ( t ) + … {a}_{jk} {s}_{k} ( t ) + … {a}_{jN} {s}_{N} ( t ) \\ ⋮ \\ {x}_{M} ( t ) = {a}_{M 1} {s}_{1} ( t ) + … {a}_{Mk} {s}_{k} ( t ) + … {a}_{MN} {s}_{N} ( t )\end{matrix} \qquad Equation ( 1 )$$

where aⱼₖ are channel coefficients representing the effects of the channel on each transmitted signal sₖ(t). A demodulated received signal xⱼ(t) typically includes a scaled version of the signal of interest and scaled versions of interfering signals. Typically, both the channel coefficients (aⱼₖ) and the original signals (sₖ(t)) are unknown at the receiver.

The sums in Equation (1) can be expressed compactly in matrix form:
x=As Equation (2)

where x=[x₁(t), . . . , x_{M}(t)] is the received signal vector, s=[s₁(t), . . . , s_{N}(t)]^{T} is the transmitted signal vector, and A is an M×N mixing matrix made up of channel coefficients aⱼₖ for j=1, . . . , M and k=1, . . . , N. The signal separation processing module 112 generates a separation matrix W which is multiplied by x to obtain a separated signal vector y=[y₁(t), . . . , y_{N}(t)]. The resulting separated signal vector y at the output of the signal separation processing module 112 may also be expressed in terms of the transmitted signal vector s and the channel matrix A:
y=W(As)=Wx. Equation (3)
The separated signal vector y estimates the transmitted signal vector s and is a subset of s in possibly a different order and with possibly different scaled values. If all the signals are not separable, the more general form of the ICA output vector y is:
y=W(As)+Wn=Wx+Wn Equation (4)
where vector n is residual noise caused by unidentifiable sources.

As long as the transmitted signals are statistically independent in some measurable characteristic, and the signal sums of the received signals are linearly independent from each other, one or more of the blind signal separation techniques may be used to determine the signal separation matrix W.

Separating desired signals can be used to increase the power of the desired received signals, whereas separating undesired signals can be used to reduce noise power, which in turn improves the signal-to-noise ratio (SNR) of the desired signals. The rank of mixing matrix A, or equivalently the rank of the separation matrix W, determines how many signals can actually be separated by blind signal separation methods such as ICA, where the rank refers to the number of independent rows or columns in the matrix. Therefore, an important part in the design of signal separation techniques is to build mixing matrix A with a sufficient rank to be able to separate desired and undesired signals of interest.

The following techniques may be used for populating the mixing matrix A to increase its rank:
1) Employing I and Q channels each coded with unique data that doubles the number of independent rows in the mixing matrix. Differentially encoded I and Q channels may also double the information in the mixing matrix provided they meet certain statistical independence criteria that are waveform dependant.
2) Employing multiple uncorrelated antennas, such that each antenna provides an independent set of entries in the mixing matrix.
3) Employing multiple correlated active or parasitic antennas such that each antenna provides an independent set of entries in the mixing matrix.
4) Employing antennas with unequal polarizations such that each antenna with dual- or tri-polarization may provide respectively two or three independent sets of mixing matrix entries.
5) Employing an antenna array nominally utilized in one orientation plane with deformation control in the orthogonal plane providing two independent sets of entries in the mixing matrix for each independent deformation over a portion of the plane.
6) Exploiting spreading codes, specifically:
   a. Providing an independent set of entries in the mixing matrix for each known Walsh code (i.e. spreading code) of a received signal before de-spreading.
   b. Providing an independent set of entries in the mixing matrix for each known Walsh code of a received signal after de-spreading.
   c. Providing one or two mixing matrices where one is built from the descrambled signals generated by mixing received signals with pseudo-noise (PN) codes to separate intra-cell signals, and the other is built from the despread signals generated by mixing received signals with Walsh codes to separate imperfectly de-correlated signals.
7) Extracting different received versions of a signal due to varying channel propagation effects to provide corresponding sets of independent entries in the mixing matrix.

Each of the listed techniques above may be used alone or in combination with any of the other techniques. For example, I and Q channels may be employed with any of the antenna arrangements listed in techniques 2-5 above to populate the matrix with twice the number of antenna elements. In another example, two antennas at uncorrelated positions may be employed, each with two unequal polarization elements and each with I and Q channels to obtain up to 8 (i.e. 2×2×2) independent signal samples xⱼ(t) and hence 8 independent sets of entries in the mixing matrix.

The techniques listed above increase the rank of the mixing matrix to correspondingly improve the performance of signal separation. However, increasing the size of the mixing matrix also increases the signal separation processing complexity. In some cases, the processing capability of a receiving device may not be able to support the large matrices resulting from an increased number of independent samples. Such cases may arise, for example, due to the size of the processing device, a constraint on the number of calculations the device can support, a power constraint of the receiver, or a combination of all of the above. Even processors that are capable of processing larger matrices may experience periods with limited processing power when, for example, the processor is concurrently running other computing tasks.

The processing complexity of signal separation methods is of particular concern in wireless communication systems employing CDMA or wideband CDMA (W-CDMA) communications including, but not limited to, CDMA2000 and high speed downlink packet access (HSDPA) systems. For example, according to a current HSDPA protocol, up to 15 different spreading codes (e.g. Walsh codes) may be known for a particular communication channel being decoded at a receiver. Additionally, there may be additional known spreading codes being used in nearby sectors and cells that may also be exploited for generating samples used in signal separation. Assuming a receiver has multiple uncorrelated receive antennas, employing all the known spreading codes times each of the antenna elements for signal separation results in a mixing matrix of rank at least 30, and possibly much higher. While this provides very robust signal demodulation, the processing complexity of large matrices is high and possibly beyond the capabilities of a receiver's processor. If the receiver is part of a battery operated handset, increased processing complexity also accelerates battery depletion and decreases the lifetime of the receiver.

CDMA IS-95, CDMA2000, HSDPA and wideband-CDMA (W-CDMA) are examples of spread spectrum wireless communications systems that make use of orthogonal spreading codes. FIG. 2 illustrates a transmitted signal that was processed using a unique spreading code prior to transmission such that the signal spectrum is spread over a large frequency band. FIG. 2 also shows a non-spread interferer signal and a noise floor that includes the sum of interfering signals spread in the channel using other orthogonal spreading codes and other noise signals that may result from, for example, receiver imperfections. At the receiver, the same spreading code is processed with the received signal that includes the desired signal, undesired interferer signals and various noise sources, for the purpose of despreading the desired signal. Despreading causes the desired signal to be reconstructed back to its original frequency bandwidth, while interferers are spread over the wide frequency band as illustrated in FIG. 3.

By using orthogonal spreading codes in CDMA systems, many signals may be transmitted simultaneously over the same frequency band. Each signal is mixed at a transmitter prior to transmission with a spreading code that is ideally orthogonal to all the other spreading codes. If the transmitted signals remain perfectly orthogonal at a receiver, then only the desired signal with the matching spreading code will be correctly despread. An example of spreading codes is Walsh codes. In the following, wherever Walsh codes are specified it is understood that any other type of spreading codes may be substituted, and vice versa.

A received signal xₖ(t) may be despread by the corresponding spreading code to recover the k^{th} transmitted signal sₖ(t) that appears as a scaled term in the sum of xₖ(t):
xₖ(t)=a₁s₁(t)+ . . . aₖsₖ(t)+a_{N}s_{N}(t) Equation (5)
Typically, the coefficient aₖ increases the amplitude of sₖ(t) in the sum of the received signal xₖ(t) and the other coefficients have a neutral scaling effect or lower the amplitude of the non-k signal terms in the sum.

In most cases, the spreading codes used to spread transmitted signals do not remain perfectly orthogonal at a receiver and have some correlation because of various channel effects and receiver imperfections. As a result, despreading a received signal with a spreading code for the desired signal may also partially reconstruct some of the received interfering signals, including CDMA and non-CDMA interfering signals. Some of these undesired signals, and in particular the CDMA signals, may have increased amplitude as a result of the despreading process, although not as significant as for the desired signal. The increased amplitude of interfering signals contributes to the noise signal and decreases the signal-to-noise ratio (SNR) of the desired signal. However, an observation used by the present invention is that the despread signals meet the criteria for blind signal separation processing.

A block diagram of a conventional receiver 400 in a CDMA system is illustrated in FIG. 4A. A signal is received by an antenna 402, demodulated by demodulation module 420 and filtered by filter 422 to remove out-of-frequency band components. Unique pseudo-noise (PN) codes, equally referred to as scrambling codes, may be mixed with transmitted signals from different sources prior to transmission to distinguish neighboring cells and/or sectors in a cellular communication system. In such cases, the demodulated received signal is also mixed with the PN code PN_{S} for its corresponding sector S, which is the process known as descrambling. Subsequently, N signals x₁, . . . , x_{N}, also referred to as data streams, are generated using N orthogonal spreading codes U₁, . . . , U_{N}. The despread signals may be provided to a type of decoder for further processing, for example the decoder 114 of FIG. 1.

FIG. 4B illustrates a prior art CDMA receiver comprising receive circuit 400 such that despread signals x₁, . . . , x_{N} are fed to a signal separation processing module 112 that uses independent component analysis (ICA) to create a separation matrix W of rank R and produces separated signals y₁, . . . , y_{N}, or a subset thereof. Signal separation processing module 112 also separates out the interfering signals z, from neighboring sectors S₁, S₂, . . . , S_{L} that interfere with the target sector S. In the case that one receive antenna 402 is used as shown in FIG. 4B, the rank of the separation matrix is equal to the number of spreading codes R=N. If receiver circuit 400 is replicated K times including K spatially separated receive antennas (not shown), then K different receive signals are despread using all N spreading codes. The rank of the resulting separation matrix W increases to R=KN and up to KN signals can be separated. Applying both PN codes and spreading codes prior to signal separation as shown in FIG. 4B may result in a large mixing matrix requiring prohibitively large amounts of processing, as discussed above.

### SUMMARY

The present invention is related to a method and apparatus for signal separation in a receiver in a wireless communication system, whereby received signals are mixed with scrambling codes and/or spreading codes in order to populate a mixing matrix used for signal separation. One or a plurality of antennas may be used to receive signals and further populate the mixing matrix in accordance with embodiments of the present invention. Signal separation provides a separation matrix used to generate both desired and interfering separated signals. In alternate embodiments of the present invention, the separation matrix is split according to scrambling and spreading code processing to decrease processing complexity and improve on the inefficiencies of the prior art. Feedback adjustment control may be used to adjust separation parameters based on generated separation matrices and separated signals.

### BRIEF DESCRIPTION OF THE DRAWING(S)

A more detailed understanding of the invention may be had from the following description of a preferred embodiment, given by way of example and to be understood in conjunction with the accompanying drawings wherein:

FIG. 1 shows a conventional wireless receiver 100 employing independent component analysis (ICA) to separate received signals;

FIG. 2 illustrates an example of a spread spectrum signal and an interferer signal;

FIG. 3 illustrates a spread spectrum signal and interferer signal after despreading;

FIG. 4A is a block diagram of a conventional code division multiple access (CDMA) receiver;

FIG. 4B is a block diagram of a conventional CDMA receiver employing signal separation;

FIG. 5 is a block diagram of a CDMA receiver employing signal separation that uses multiple antennas and the target sector's pseudo-noise (PN) code to generate a separation matrix, in accordance with a preferred embodiment of the present invention;

FIG. 6 is a block diagram of a CDMA receiver employing signal separation that uses one antenna and multiple known sector PN codes to generate a separation matrix, in accordance with a preferred embodiment of the present invention;

FIG. 7 is a block diagram of a CDMA receiver employing signal separation that combines multiple antennas and multiple known sector PN codes to generate a separation matrix, in accordance with a preferred embodiment of the present invention;

FIG. 8 is a block diagram of a CDMA receiver employing signal separation in which the separation matrix is split into separate mixing processes for known sector PN codes and known spreading codes, in accordance with a preferred embodiment of the present invention;

FIG. 9 is a block diagram of a CDMA receiver employing signal separation that uses feedback information to adjust signal separation processing based on the resulting separation matrix and decoder results, in accordance with a preferred embodiment of the present invention;

FIG. 10 is block diagram of a CDMA receiver employing pre-despreading signal separation, in accordance with a preferred embodiment of the present invention;

FIG. 11 is a block diagram of a CDMA receiver employing pre-descrambling signal separation, in accordance with a preferred embodiment of the present invention;

FIG. 12 is a block diagram of a CDMA receiver employing both pre-descrambling signal separation and pre-despreading signal separation, in accordance with a preferred embodiment of the present invention;

FIG. 13 is a block diagram of a CDMA receiver employing post-descrambling signal separation and pre-despreading signal separation, in accordance with a preferred embodiment of the present invention;

FIG. 14 is a block diagram of a CDMA receiver employing pre-descrambling signal separation and post-despreading signal separation, in accordance with a preferred embodiment of the present invention; and

FIG. 15 is a flow diagram for signal separation of received signals in accordance with the present invention.

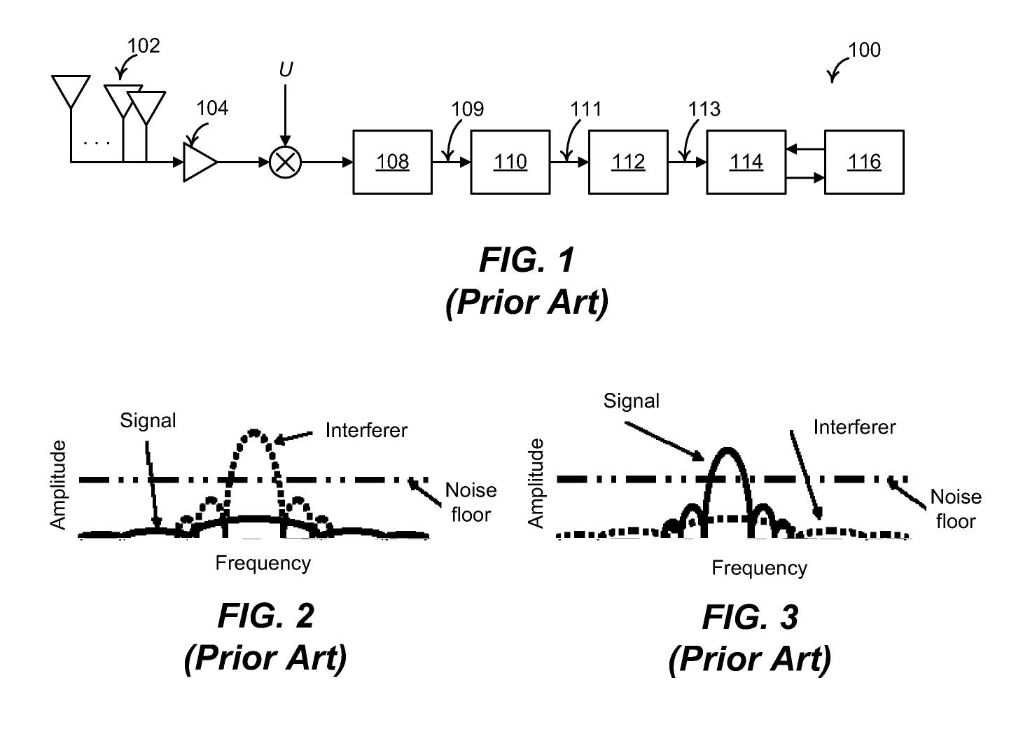

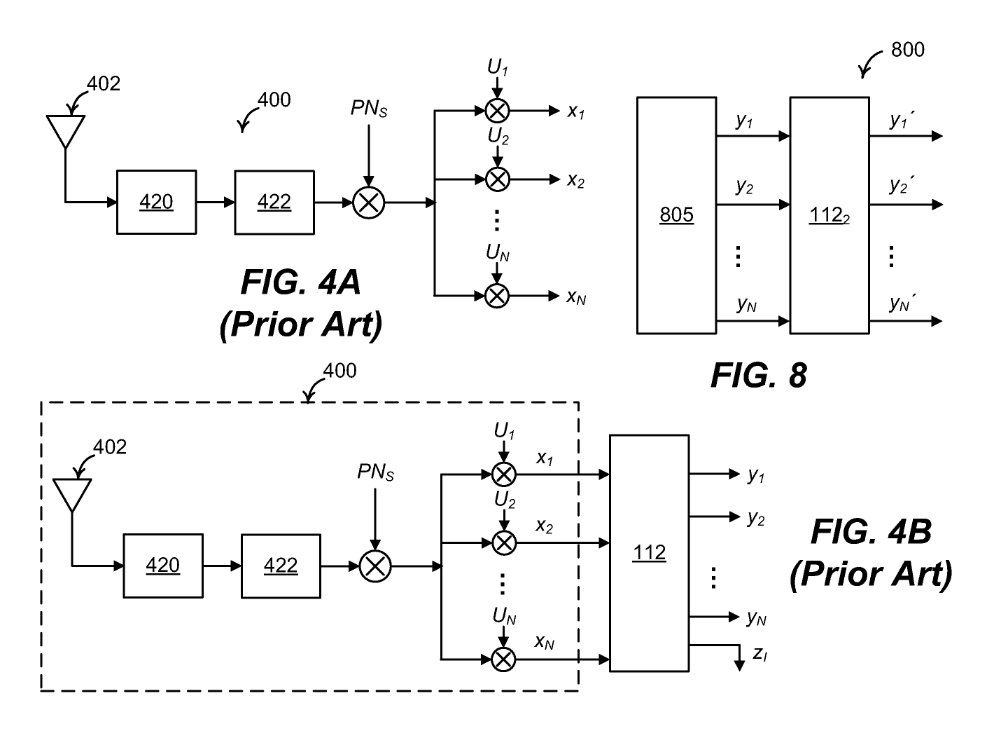

### DETAILED DESCRIPTION OF THE PREFERRED EMBODIMENT(S)

The present invention is applicable to any type of wireless communication system employing spread spectrum techniques including, but not limited to, cellular systems, mobile systems, wireless local area networks (LANs), metropolitan area network (MANs), and personal area networks (PANs), fixed access systems, ad-hoc networks and mesh networks. Examples of such wireless communication systems include 2G and 3G cellular systems including, but not limited to, Interim Standard 95 (IS-95), Code Division Multiple Access 2000 (CDMA2000), wideband-CDMA (W-CDMA), and high speed downlink packet access (HSDPA) and Universal Mobile Telecommunications System (UMTS) with frequency division duplex (FDD) and/or time division duplex (TDD).

Wireless systems typically include two types of communication stations: base stations and wireless transmit/receive units (WTRUs). When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

In the following, when referring to signal separation techniques, any known technique of signal separation may be used, including, but not limited to, independent component analysis (ICA).

According to the present invention, the spreading codes for each known transmitted signal are applied to a received signal at a receiver. Assuming there are N known spreading codes at a receiver, each spreading code despreads the corresponding transmitted signal but also partially processes some of the interfering signals as explained above, producing a set of independent despread signals each containing different information about the set of transmitted signals and meeting the requirements for independent component analysis (ICA) processing. Each independent despread signal corresponds to a row of the mixing matrix A and accordingly contributes to a row of the separating matrix W. Therefore, the number N of despread signals providing useful information is equal to the number of spreading codes being used on a common channel under the condition that the spreading codes are linearly independent. The corresponding mixing matrix has a rank at least equal to the number of spreading codes N. However, if additionally K spatially diverse antennas are used, the resulting mixing matrix has KM independent rows and a rank of KM.

According to the present invention, a CDMA receiver is able to separate up to N signals and provide them to a subsequent processing device as determined by the rank R of the separation matrix. However, not all N separated signals are necessarily needed by the subsequent processing device, and in some cases, only a subset of the separated signals contains information of interest. Therefore, the most robust signal separation produces all N possible signal streams, whereas less processing can be used generating fewer separated signals when only a subset of the signals are useful. This is discussed further below.

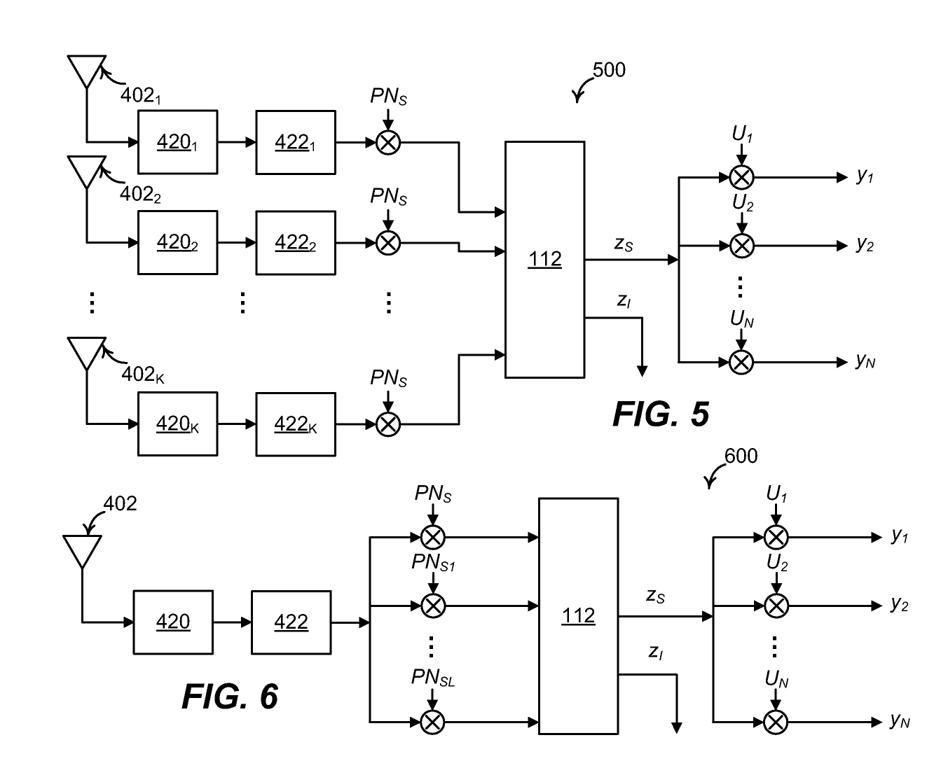

FIG. 5 shows a CDMA receiver 500 employing K diversity antennas 402₁ to 402_{K} in accordance with an embodiment of the present invention. Demodulators 420₁ to 420_{K} and filters 422₁ to 422_{K} are applied to the received signals of each respective antenna 402₁ to 402_{K}. The receiver signals are mixed with PN code PN_{S} of the desired cell or sector S prior to building a mixing matrix in the signal separation processing module 112. The signal separation module 112 can separate the signals z_{S} created with the PN code PN_{S} corresponding to the desired cell or sector S from interferer signal zₗ from neighboring cells or sectors S₁, S₂, . . . , S_{L}. Signals z_{S} and zₗ may each be a combination of signals, for example, they may include signals with orthogonal spreading codes which can be subsequently demodulated by despreading techniques as described below. By way of example, for a receiver with K=2 antennas, an interferer signal can be identified as the most significant non-Gaussian signal separated from the total received signal. If a Gaussian noise signal is the most significant interferer, it can also be divided out by signal separation techniques. Gaussian noise type interferers are likely to occur in CDMA systems, because there are many spread signals sharing a channel which are designed to have random noise like characteristics to all but their own code usage, and by the law of large numbers, the large sum of interfering signals approaches a Gaussian distribution. At the output of the signal separation processing module 112 the desired signal from sector S z_{S} with a significant amount of the interference already removed can then be mixed with the spreading codes U₁, . . . , U_{N} to provide separated signals y₁, . . . , y_{N}.

FIG. 6 shows another embodiment of the present invention in which CDMA receiver 600 makes use of knowledge of scrambling codes PN_{S1}, PN_{S2}, . . . , PN_{SL} of corresponding neighboring sectors S₁, S₂, . . . , S_{L}. A signal received by antenna 402, demodulated by demodulator 420 and filtered by filter 422, is mixed with each of the scrambling codes PN_{S} and PN_{S1}, PN_{S2}, . . . , PN_{SL} from which the outputs are used by the signal separation module 112 to create a separation matrix. Mixing with all the known scrambling codes provides information about mutual interference of signals from the different sectors enabling signal separation processing to remove interference caused by the different sectors. The resulting rank of the mixing matrix is equal to the total number of known scrambling codes L+1. Accordingly, the signal separation module 112 is able to separate the signals z_{S} originating from the desired sector S and the interferers zₗ from the L other sectors. The total signal z_{S} can be mixed with spreading codes U₁, . . . , U_{N} to provide separated signals y₁, . . . , y_{N} for sector S.

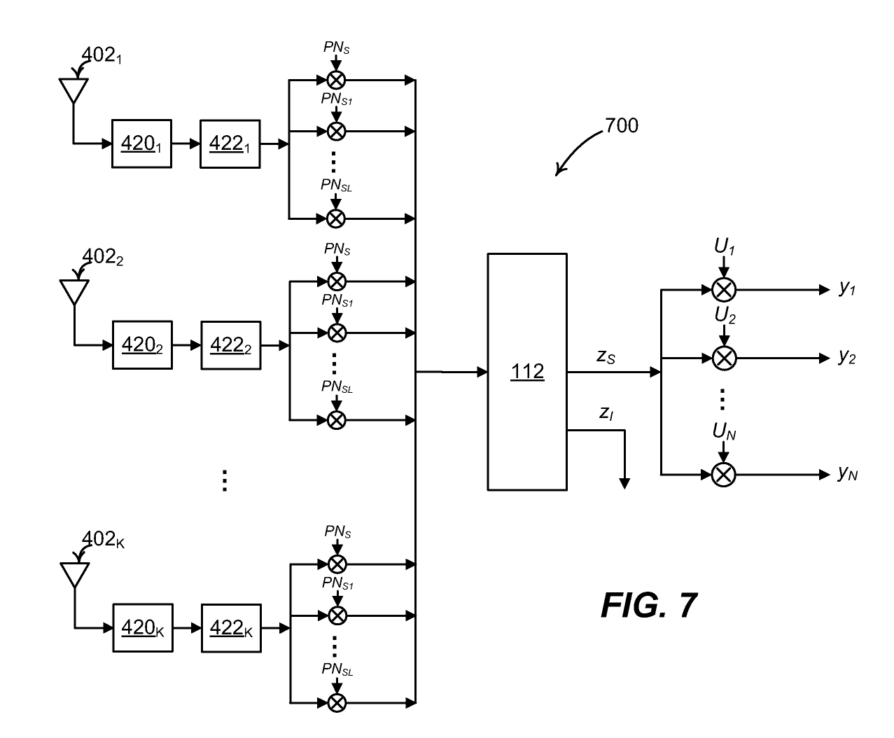

The multiple antenna implementation of FIG. 5 can effectively be combined with the embodiment of FIG. 6 as shown in FIG. 7, in accordance with an embodiment of the present invention. Referring to FIG. 7, demodulators 420₁ to 420_{K} and filters 422₁ to 422_{K} are applied to the received signals of each respective antenna 402₁ to 402_{K}. Each demodulated signal is mixed with all the scrambling codes PN_{S} and PN_{S1}, PN_{S2}, . . . , PN_{SL} prior to signal separation module 112. The resulting rank of the separation matrix produced by signal separation processing module 112 is K(L+1) such that the sector S signals z_{S} and sectors S₁, S₂, . . . , S_{L} signals zₗ are separated and can be despread as described above.

The data streams y₁, . . . , y_{N} output following the mixing with spreading codes U₁, . . . , U_{N} in the embodiments of FIGS. 5, 6, and 7 can be further improved by applying signal separation to a matrix built from the signals y₁, . . . , y_{N} to remove more noise and interference, as shown in FIG. 8, in accordance with the present invention. In FIG. 8, receiver circuit 805 may be any receiver circuit with a first stage of signal separation producing separated signals Y₁, . . . , y_{N} including, but not limited to receiver circuits 500, 600 and 700. Signal separation module 112₂ performs a second stage of signal separation wherein signals y₁, . . . , y_{N} used to create the mixing matrix provide information about mutual interference of the signals with different spreading codes enabling signal separation processing to remove interference between signals from the same sector. In this case, the rank of the separating matrix may be equal to the number of data streams, rather than a larger factor thereof. Signal separation module 112₂ outputs improved separated signals y₁′, . . . , y_{N}′.

A conventional CDMA receiver may provide the same quality of signal separation as in the embodiment of FIG. 8, but requires one large signal separation matrix containing all the despreading and descrambling samples, and incurs large processing complexity for signal separation proportional to the cube of the rank of the mixing matrix. In contrast, the processing complexity of receiver 800 of FIG. 8 wherein two separation matrices are processed separately is shown to be considerably lower than the prior art. Table 1 compares relative processing complexity of a single matrix signal separation implementation to the two matrices signal separation implementation of the present invention as shown in FIG. 8. Table 1 includes examples of processing loads for different receiver implementations such as number of antennas, number of spreading codes and number of sector codes. The processing complexity refers to an estimate of the number of multiplications needed to solve a separation matrix, which is substantially higher when processed as a single matrix. In one example using a brute force approach, the processing complexity increases as the cube of the relative rank of the mixing matrices. When the number of sectors increases from 1 to 2 as shown in Table 1, the complexity increases by a factor proportional to 2-cubed, implying an increased processing complexity of 262,144=8*32,768. The rank 32 matrix compared in the table is a typical size of a separation matrix in a High-Speed Downlink Packet Access (HSDPA) receiver.

TABLE 1
Example comparisons of processing loads for signal separation

| | | | | | | | Ratio of | Ratio of | |
|---|---|---|---|---|---|---|---|---|---|
| Relative | | | | Processing | Processing | | Processing | Processing | |
| processing | | | | complexity | complexity | | complexity | complexity | |
| exponent | Number | Number | Number | for 1 | for 2 | | for 1 | for 2 | |
| of 1 | of | of | of sector | matrix | matrices | Ratio of | matrix | matrices | |
| matrix | antenna | spreading | specific | signal | signal | 1 matrix | relative to | relative to | |
| over 2 | ports | codes | codes | separation | separation | versus 2 | 1 rank 32 | 1 rank 32 | Usage |
| matrices | (K) | (N) | (L) | processing | processing | matrices | matrix | matrix | scenario |
| 3 | 2 | 16 | 1 | 32,768 | 4,104 | 8.0 | 1 | 0.13 | HSDPA |
| | | | | | | | | | within |
| | | | | | | | | | sector |
| 3 | 2 | 16 | 2 | 262,144 | 4,160 | 63.0 | 8 | 0.13 | HSDPA |
| | | | | | | | | | with 2 |
| | | | | | | | | | sector |
| | | | | | | | | | overlap |
| 3 | 2 | 16 | 3 | 884,736 | 4,312 | 205.2 | 27 | 0.13 | HSDPA |
| | | | | | | | | | with 3 |
| | | | | | | | | | sector |
| | | | | | | | | | overlap |

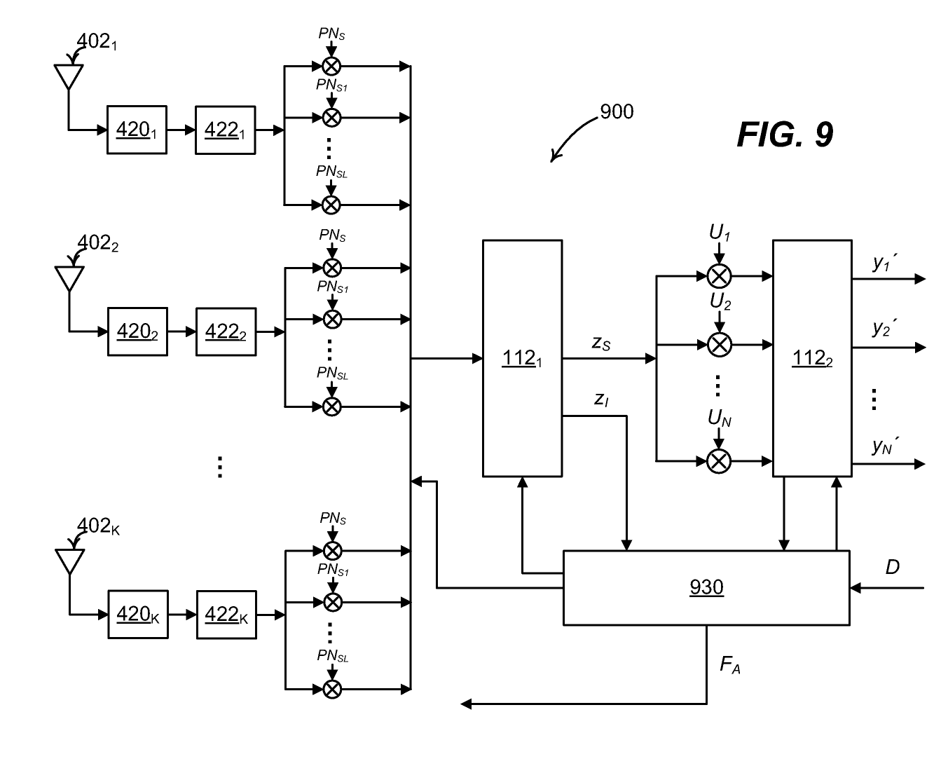

There is flexibility in the use of a separation processing modules and in the necessary rank of the resulting separation matrix or matrices to meet the desired signal separation requirements. In another embodiment of the present invention, FIG. 9 shows a CDMA receiver 900 including the components of receiver 700 of FIG. 7 in combination with the CDMA receiver 800 of FIG. 8 as described above and which additionally includes an adjustment processing module 930. The adjustment processing module 930 monitors the signal separation matrices produced by signal separation modules 112₁ and 112₂ and decoding results D from a post processing decoder (not shown) to determine adjustments to receiver processing based on the acquired information. The information received from signal separation modules may include, but is not limited to, separated signals zₗ, data streams y₁′, . . . , y_{N}′ and/or the determined signal separation matrix values. Decoding results D may include, but are not limited to, error rates, error occurrence statistics, and/or the signal to noise ratio observed. Possible adjustment actions of the adjustment processing module 930 include, but are not limited to, changing the number of spreading and/or scrambling codes used and changing antenna usage via output information F_{A}. For example, some receivers are equipped with antenna arrays that are controllable using beamforming. The adjustment processing module 930 can adjust the antenna array controls using information F_{A} to change the results of one or both of the signal separation processing modules 112₁ and 112₂ as well as the post decoding processing. Other examples of adjustment processing actions under different conditions in accordance with the present invention are listed in Table 2. A main goal of the adjustment processing module 930 is to further reduce processing requirements related to the size of the separation matrices, however, it may also affect the amount of processing in the receiver, possibly increasing it, with respect to, for example, the number of iterations of signal separation, sampling rates of received signals, and reuse of calculations based on coherence time.

TABLE 2
Examples of feedback and control options

| | Possible adjustment action | Likely situation |
|---|---|---|
| Sector scrambling code | | |
| separation Information | | |
| Some codes are producing | Eliminate codes for insignificant | Device is well within sector and or |
| insignificant values relative to | sectors. If decoding is not robust | there is no significant usage in |
| the desire code. | enough try other sector codes. | specific cells. |
| High correlation exists and is | Increase sector scrambling code | Device is near edge of cell. |
| not being adequately reduced. | usage. When available, change | Alternately the terrain could be |
| | antenna control to reject interferers. | very irregular and non-adjacent |
| | | transmitters could be interfering |
| | | within the cell's nominal robust |
| | | coverage area. |
| Spreading code separation | | |
| Information | | |
| There is low correlation | Determine separation matrix with | Device is outside in a low scatter |
| between codes. | iteration matrix seeded with low | environment. |
| | values. Reduce codes to this | |
| | receiver only set. | |
| There is high correlation | Include all possible spreading | Device is in a high scatter |
| between codes. | codes including those not being | environment. |
| | used for this device's receiver. | |
| | Increase the matrix rank when | |
| | possible by means such as I and Q | |
| | channel splitting. | |
| Data decoder information | | |
| Low signal to noise ratio. | Increase robustness of either or | Insufficient matrix rank or code set |
| | both separation stages. When | selection. |
| | available change antenna control. | |

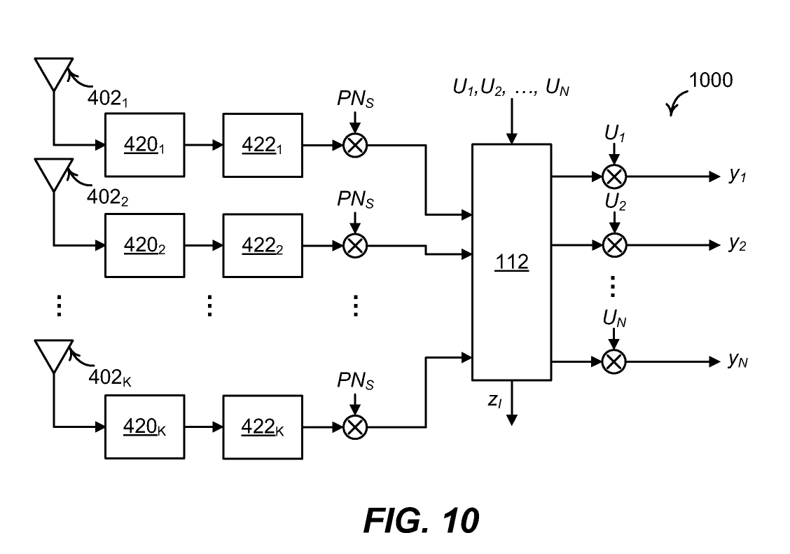

FIGS. 10 through 14 illustrate additional embodiments of the present invention utilizing relevant scrambling codes and spreading codes to separate signals in a CDMA receiver. Specifically, in receiver 1000 of FIG. 10, demodulators 420₁ to 420_{K} and filters 422₁ to 422_{K} are applied to the received signals of each respective antenna 402₁ to 402_{K}. The received signals, mixed with PN code PN_{S} of the desired sector S, are used by the signal separation processing module 112 along with spreading codes U₁, . . . , U_{N} to separate N corresponding signals, which are respectively despread by spreading codes U₁, . . . , U_{N} to provide despread separated signals y₁, . . . , y_{N}. Interferer signals zₗ from neighboring cells or sectors are also separated.

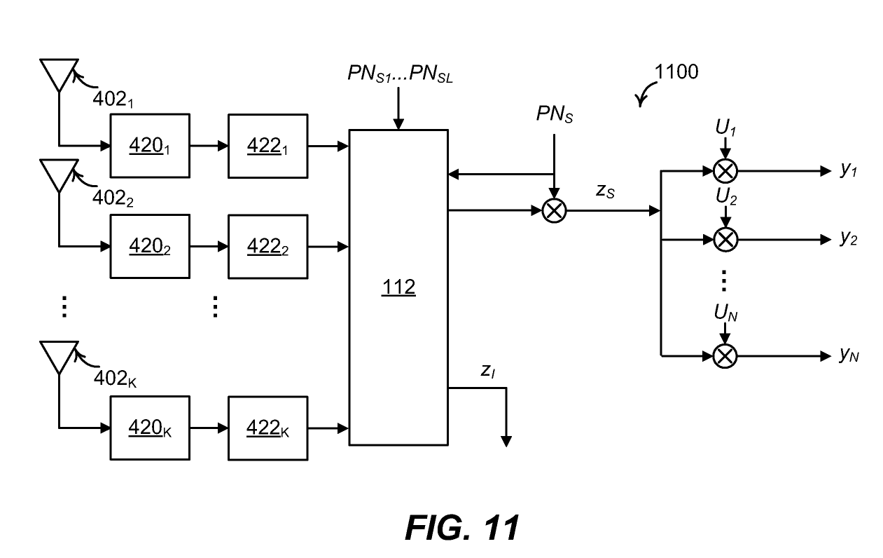

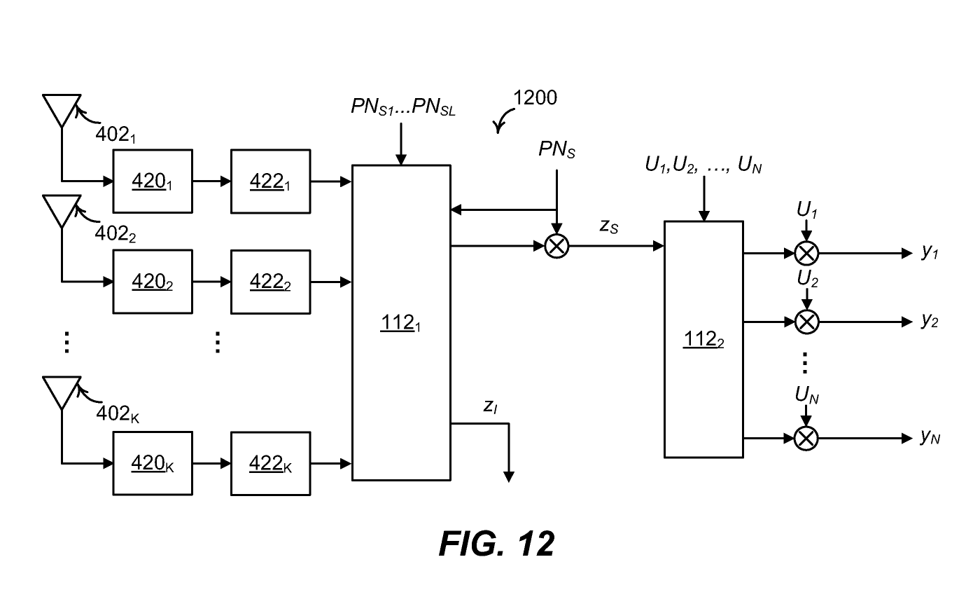

In receiver 1100 of FIG. 11, demodulators 420₁ to 420_{K} and filters 422₁ to 422_{K} are applied to the received signals of each respective antenna 402₁ to 402_{K}. The demodulated and filtered received signals are used by the signal separation processing module 112 along with the known scrambling codes PN_{S} and PN_{S1}, . . . , PN_{SL} to generate a separating matrix of size K(L+1). The interfering signals zₗ from other sectors and separated out, and the desired separated signals are descrambled with the code of the desired sector PN_{S} to produce signal z_{S} which is despread using spreading codes U₁, . . . , U_{N} to provide despread separated signals y₁, . . . , y_{N}. Receiver 1200 of FIG. 12 is like receiver 1100 with an additional separation processing module 112₂ that processes signal z_{S} and spreading codes U₁, . . . , U_{N} producing N signals that are subsequently mixed with corresponding spreading codes U₁, . . . , U_{N} producing separated signals y₁, . . . , y_{N}.

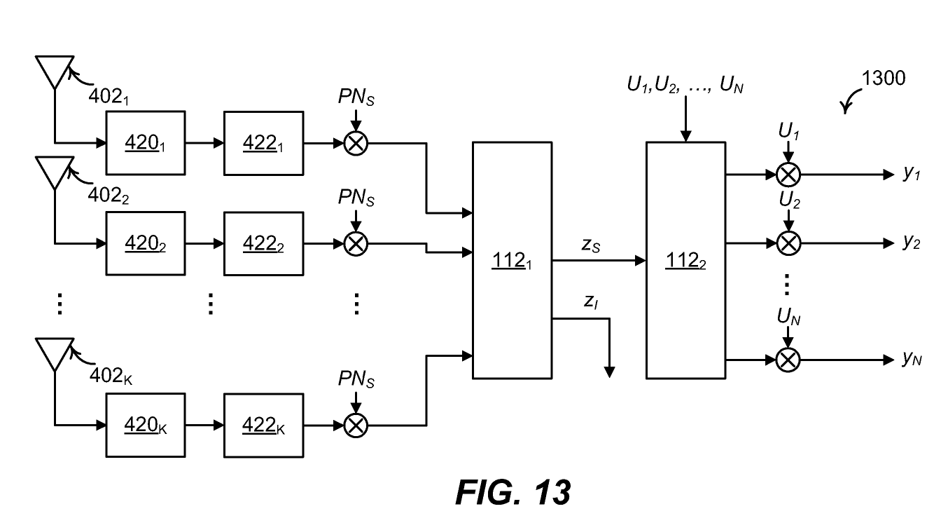

Receiver 1300 of FIG. 13 is similar to receiver 500 of FIG. 5 with an additional separation processing module 112₂ that processes signal z_{S} and spreading codes U₁, . . . , U_{N} producing N signals that are subsequently mixed with corresponding spreading codes U₁, . . . , U_{N} producing separated signals y₁, . . . , y_{N}.

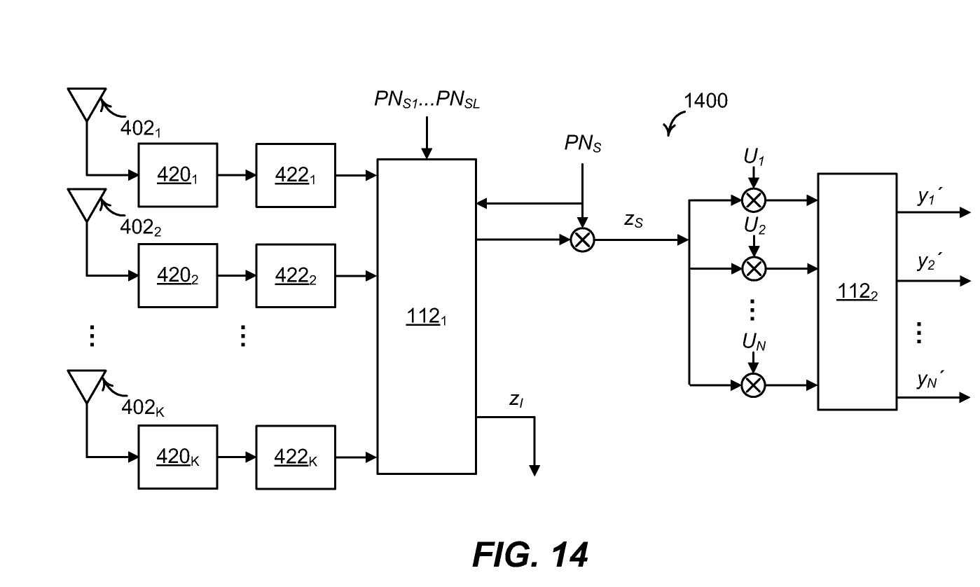

The receiver 1400 of FIG. 14 is a variation of receiver 1200 in FIG. 12 where a second signal separation processing module 112₂ is applied following despreading instead of before despreading. In this case, N despread signals are used to populate the mixing matrix of separation processing module 112₂, exploiting information resulting from interference of different spreading codes.

The various embodiments of the present invention with respect to possible uses of signal separation processing are summarized in Table 3 with references to the relevant embodiments in the figures.

TABLE 3
Possible combinations of signal separation processing with despreading
and descrambling

| Scrambling Codes | Spreading Codes | Preferred Embodiment |
|---|---|---|
| Pre-descramble | Not used | |
| Not used | Pre-despread | |
| Post-descramble | Not used | FIGS. 5, 6, 7 |
| Not used | Post-despread | |
| Pre-descramble | Pre-despread | |
| Post-descramble | Pre-despread | |
| Pre-descramble | Post-despread | |
| Post-descramble | Post-despread | |

It is also possible to perform separate stages of signal separation both before and after descrambling and despreading operations. However, only marginal gains can be expected because the useful information contained in the interfering signals would have already been exploited.

Because the various proposed embodiments will have benefits varying with the prevailing conditions, another embodiment of the present invention includes several of the signal separation processing methods listed in Table 3 as realized in the figures, such that a controller is able to switch from one method to another as desired. In such an implementation, the various processing stages, including signal separation processing, may be implemented in a programmable device such as a digital signal processor (DSP), a hardware reconfigurable device under processor control, or a combination thereof.

All of the methods listed in Table 3 could be further enhanced with an adjustment processing device 930 as shown in FIG. 9 used in combination with both post-descramble and post-despread signal processing implementations.

Furthermore, in accordance with the present invention, any of the techniques 1-7 described above for increasing the rank of the separation matrix, such as using both I and Q channels, could be used in combination with any of the embodiments of the present invention for extremely robust signal separation. Whether the additional techniques are useful typically depends on the application.

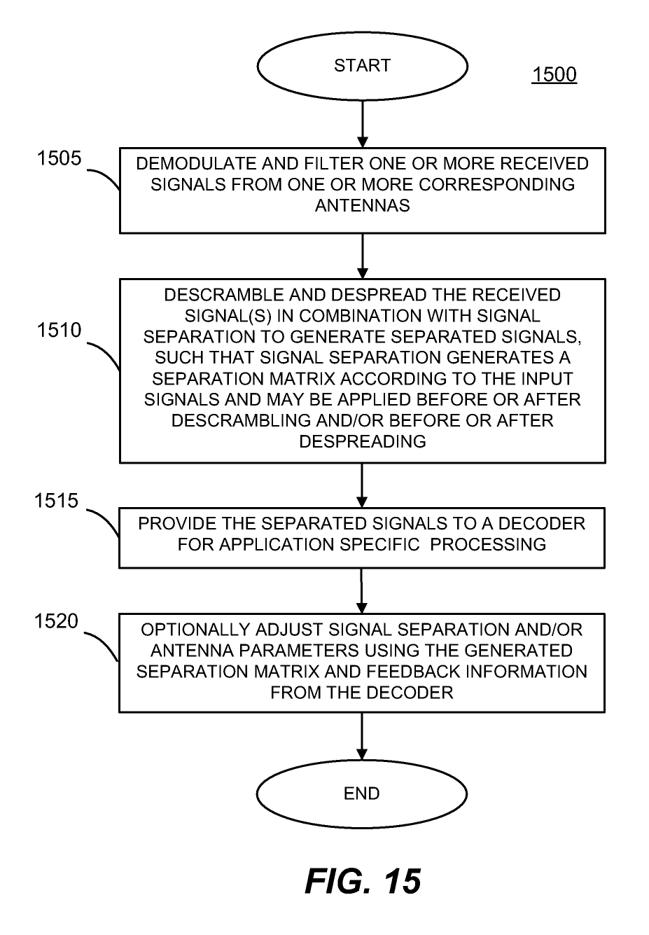

FIG. 15 generally illustrates a method for signal separation in a spread spectrum receiver in accordance with the present invention. In step 1505, one or more received signals from one or more corresponding antennas are demodulated and filtered. In step 1510, the received signals are descrambled and despread in combination with signal separation to generate separated signals, such that signal separation may be applied before or after descrambling and/or before or after despreading. Descrambling may be applied with the target sector's pseudo-noise (PN) code or all know PN codes corresponding to neighboring sectors and despreading may be done will all known spreading codes. In step 1515, the separated signals are provided to a decoder for application specific processing. In step 1520, the generated separation matrix generated by signal separation in step 1510 and feedback information from the decoder in step 1515 can optionally be used to adjust signal separation and/or antenna parameters which includes, but is not limited to, the adjusting of number of scrambling codes or spreading codes used in signal separation and which antennas are used for receiving signals.

The present invention may be implemented on an integrated circuit, such as an application specific integrated circuit (ASIC), multiple integrated circuits, DSP, logical programmable gate array (LPGA), multiple LPGAs, discrete components, or a combination of integrated circuit(s), LPGA(s), and discrete component(s).

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any integrated circuit, and/or a state machine.

A processor in association with software may be used to implement a radio frequency transceiver for use in a wireless transmit receive unit (WTRU), user equipment, terminal, base station, radio network controller, or any host computer. The WTRU may be used in conjunction with modules, implemented in hardware and/or software, such as a camera, a videocamera module, a videophone, a speakerphone, a vibration device, a speaker, a microphone, a television transceiver, a handsfree headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless receiver, a method for separating signals comprising:
receiving combined signals;
demodulating and filtering the received combined signals to generate demodulated signals;
mixing the demodulated signals with known codes to generate mixed signals;
generating a separation matrix based on the mixed signals; and
generating separated signals by multiplying the mixed signals with the separation matrix.

2. The method of claim 1 wherein the received combined signals are spread spectrum signals.

3. The method of claim 1 wherein the received combined signals are code division multiple access (CDMA) signals.

4. The method of claim 1 wherein the known codes include a pseudo-noise (PN) code associated with a target sector.

5. The method of claim 4 wherein the known codes further include a plurality of PN codes associated with a plurality interferer sectors.

6. The method of claim 1 wherein the separated signals include desired signals and interferer signals.

7. The method of claim 6 wherein the interferer signals include a most significant non-Gaussian signal.

8. The method of claim 6 wherein the interferer signals include a most significant Gaussian signal.

9. The method of claim 6 further comprising despreading the separated desired signals with a plurality of known spreading codes to generate a plurality of despread separated signals.

10. The method of claim 9 wherein the known spreading codes are Walsh codes.

11. The method of claim 9 further comprising:
generating a second separation matrix based on the despread separated signals; and
generating improved separated signals by multiplying the despread separated signals with the second separation matrix.

12. The method of claim 11 further comprising:
adjusting signal separation parameters according to at least one of the following: the separation matrix, the second separation matrix, the separated desired signals, the separated interferer signals, the improved separated signals, and decoding results.

13. The method of claim 12 wherein adjusting signal separation parameters includes at least one of the following: changing the number of known codes, changing the number of spreading codes and changing antenna array controls.

14. The method of claim 12 wherein the decoding results are based on the separated desired signals.

15. The method of claim 12 wherein the decoding results include at least one of the following: error rates, error occurrence statistics, and an observed signal to noise ratio.

16. The method of claim 9 wherein the generating a separation matrix is also based on the plurality of spreading codes.

17. The method of claim 6 further comprising:
generating a second separation matrix based on the separated desired signals and a plurality of known spreading codes; and
generating improved separated signals by multiplying the separated desired signals with the second separation matrix.

18. The method of claim 17 further comprising despreading the improved separated signals with the plurality of known spreading codes to generate a plurality of despread separated signals.

19. The method of claim 1 wherein the received combined signals are provided individually by a signal antenna.

20. The method of claim 1 wherein the received combined signals are a plurality of received combined signals provided together by a plurality of corresponding antennas.

21. The method of claim 20 wherein the plurality of antennas includes uncorrelated antennas, each antenna providing a received signal.

22. The method of claim 20 wherein the plurality of antennas includes correlated active and parasitic antennas, each active antenna providing a received signal and each corresponding parasitic antenna providing a modified version of said received signal.

23. The method of claim 20 wherein the plurality of antennas have unequal polarization, each antenna providing two independent received signals if dual-polarized and three independent received signals if tri-polarized.

24. The method of claim 20 wherein the plurality of antennas form an antenna array, each antenna with a first orientation plane and deformation control in a second orientation plane orthogonal to the first orientation plane, each plane providing an independent received combined signal.

25. The method of claim 1 further comprising extracting different received versions of the received combined signal and demodulating and filtering each of the received versions to generate a plurality of demodulated signals.

26. The method of claim 1 wherein the received signals include I and Q channels.

27. In a wireless receiver, a method for separating signals from received combined signals, the method comprising:
receiving combined signals;
demodulating and filtering the received combined signals to generate demodulated signals;
generating a separation matrix based on the demodulated signals and a plurality of pseudo-noise (PN) codes;
generating separated desired signals and separated interferer signals by multiplying the demodulated signals with the separation matrix; and
mixing the separated desired signals with a PN code associated with a target sector to produce mixed desired signals.

28. The method of claim 27 further comprising despreading the mixed desired signals with a plurality of known spreading codes to generate a plurality of despread separated signals.

29. The method of claim 28 further comprising:
generating a second separation matrix based on the despread separated signals; and
generating improved separated signals by multiplying the despread separated signals with the second separation matrix.

30. The method of claim 27 further comprising:
generating a second separation matrix based on the mixed desired signals and a plurality of known spreading codes;
generating improved separated signals by multiplying the despread separated signals with the second separation matrix; and
despreading the improved separated signals with the plurality of known spreading codes to generate a plurality of despread separated signals.

31. A receiver for separating signals comprising:
a plurality of antennas configured to receive a vector of received combined signals;
a plurality of demodulators configured to demodulate the vector of received combined signals to generate a vector of demodulated signals;
a plurality of filters configured to filter the vector of demodulated signals to generate a vector of filtered signals;
a plurality of mixers configured to mix the vector of filtered signals with known codes to generate a vector of mixed signals;
a processor configured to generate a separation matrix based on the vector of mixed signals; and
the processor configured to produce separated signals by multiplying the vector of mixed signals with the separation matrix.

32. A wireless transmit receive unit (WTRU) comprising the receiver of claim 31.

33. A base station comprising the receiver of claim 31.

34. The receiver of claim 31 wherein the received combined signals are spread spectrum signals.

35. The receiver of claim 31 wherein the received combined signals are code division multiple access (CDMA) signals.

36. The receiver of claim 31 wherein the known codes include a pseudo-noise (PN) code associated with a target sector.

37. The receiver of claim 36 wherein the known codes further include a plurality of PN codes associated with a plurality interferer sectors.

38. The receiver of claim 31 wherein the separated signals include desired signals and interferer signals.

39. The receiver of claim 38 wherein the interferer signals include a most significant non-Gaussian signal.

40. The receiver of claim 38 wherein the interferer signals include a most significant Gaussian signal.

41. The receiver of claim 38 further comprising:
a plurality of despreaders configured to despread the separated desired signals with a plurality of known spreading codes to generate a plurality of despread separated signals.

42. The receiver of claim 41 wherein the known spreading codes are Walsh codes.

43. The receiver of claim 41 wherein:
the processor is configured to generate a second separation matrix based on the despread separated signals; and
the processor is configured to generate improved separated signals by multiplying the despread separated signals with the second separation matrix.

44. The receiver of claim 43 further comprising:
a controller configured to adjust signal separation parameters according to at least one of the following: the separation matrix, the second separation matrix, the separated desired signals, the separated interferer signals, the improved separated signals, and decoding results.

45. The receiver of claim 44 wherein the controller is configured to adjust signal separation parameters including at least one of the following: changing the number of known codes, changing the number of spreading codes and changing antenna array controls.

46. The receiver of claim 44 wherein the decoding results are based on the separated desired signals.

47. The receiver of claim 44 wherein the decoding results include at least one of the following: error rates, error occurrence statistics, and an observed signal to noise ratio.

48. The receiver of claim 41 wherein the processor is configured to generate a separation matrix further based on the plurality of spreading codes.

49. The receiver of claim 38 wherein:
the processor is configured to generate a second separation matrix based on the separated desired signals and a plurality of known spreading codes; and
the processor is configured to generate improved separated signals by multiplying the separated desired signals with the second separation matrix.

50. The receiver of claim 49 further comprising:
despreaders configured to despread the improved separated signals with the plurality of known spreading codes to generate a plurality of despread separated signals.

51. The receiver of claim 31 wherein the plurality of antennas includes uncorrelated antennas, each antenna providing a received signal.

52. The receiver of claim 31 wherein the plurality of antennas includes correlated active or parasitic antennas, each active antenna providing a received signal and each corresponding parasitic antenna providing a modified version of said received signal.

53. The receiver of claim 31 wherein the plurality of antennas have unequal polarization, each antenna providing two independent received signals if dual-polarized and three independent received signals if tri-polarized.

54. The receiver of claim 31 wherein the plurality of antennas form an antenna array, each antenna with a first orientation plane and deformation control in a second orientation plane orthogonal to the first orientation plane, each plane providing an independent received combined signal.

55. The receiver of claim 31 further comprising:
a decoder configured to extract different received versions of the vector of received combined signals.

56. The receiver of claim 31 wherein the received combined signals include I and Q channels.

57. A receiver for separating signals comprising:
a plurality of antennas configured to receive a vector of received combined signals;
a plurality of demodulators configured to demodulate the vector of received combined signals to generate a vector of demodulated signals;
a plurality of filters configured to filter the vector of demodulated signals to generate a vector of filtered signals;
a processor configured to generate a separation matrix based on the vector of filtered signals and a plurality of pseudo-noise (PN) codes; and
the processor configured to produce separated signals by multiplying the vector of filtered signals with the separation matrix; and
a plurality of mixers configured to mix the separated desired signals with a PN code associated with a target sector to produce mixed desired signals.

58. The receiver of claim 57 further comprising:
despreaders configured to despread the mixed desired signals with a plurality of known spreading codes to generate a plurality of despread separated signals.

59. The receiver of claim 58 wherein:
the processor is configured to generate a second separation matrix based on the despread separated signals; and
the processor is configured to generate improved separated signals by multiplying the despread separated signals with the second separation matrix.

60. The receiver of claim 57 wherein:
the processor is configured to generate a second separation matrix based on the mixed desired signals and a plurality of known spreading codes; and
the processor is configured to generate improved separated signals by multiplying the despread separated signals with the second separation matrix, further comprising:
despreaders configured to despread the improved separated signals with the plurality of known spreading codes to generate a plurality of despread separated signals.
